(19) United States
(12) Patent Application Publication
(10) Pub. No.: US 2023/0341190 A1
(43) Pub. Date: Oct. 26, 2023

(54) ELECTROFORMED HEAT EXCHANGER WITH EMBEDDED PULSATING HEAT PIPE

(71) Applicant: Raytheon Company, Waltham, MA (US)

(72) Inventors: Trae M. Blain, Plano, TX (US); James S. Wilson, Hurst, TX (US)

(21) Appl. No.: 17/660,186

(22) Filed: Apr. 21, 2022

(51) Int. Cl. F28D 15/02; C25D 1/00

(52) U.S. Cl. CPC F28D 15/0266; C25D 1/003; F28F 2255/00

(57) ABSTRACT

A method includes using electroforming to deposit a first portion of material. The method also includes placing a preformed tube on the first portion of material, where the preformed tube includes multiple capillary pathways and multiple bends. The method further includes using electroforming to deposit a second portion of material over the first portion of material and over the preformed tube to form a heat exchanger. The preformed tube forms at least a portion of a pulsating heat pipe within the heat exchanger, and the pulsating heat pipe is configured to transport thermal energy through the heat exchanger.

### TECHNICAL FIELD

This disclosure is directed in general to thermal management systems. More specifically, this disclosure is directed to an electroformed heat exchanger with an embedded pulsating heat pipe.

### BACKGROUND

Thermal management is typically a desired or required function in many systems and is used to maintain the operating temperatures of electronic circuits or other components within acceptable temperature ranges. Various types of structures have been used in thermal management systems in order to remove thermal energy from electronic circuits or other components. Some of these structures rely on the use of fluid, such as liquid or vapor, to transport thermal energy.

### SUMMARY

This disclosure is directed to an electroformed heat exchanger with an embedded pulsating heat pipe.

In a first embodiment, a method includes using electroforming to deposit a first portion of material. The method also includes placing a preformed tube on the first portion of material, where the preformed tube includes multiple capillary pathways and multiple bends. The method further includes using electroforming to deposit a second portion of material over the first portion of material and over the preformed tube to form a heat exchanger. The preformed tube forms at least a portion of a pulsating heat pipe within the heat exchanger, and the pulsating heat pipe is configured to transport thermal energy through the heat exchanger.

In a second embodiment, an apparatus includes a heat exchanger having a first portion of electroformed material, a preformed tube over the first portion of electroformed material, and a second portion of electroformed material over the first portion of electroformed material and over the preformed tube. The preformed tube includes multiple capillary pathways and multiple bends. The preformed tube represents at least a portion of a pulsating heat pipe within the heat exchanger, and the pulsating heat pipe is configured to transport thermal energy through the heat exchanger.

In a third embodiment, a method includes transporting thermal energy through a heat exchanger. The heat exchanger includes a first portion of electroformed material, a preformed tube over the first portion of electroformed material, and a second portion of electroformed material over the first portion of electroformed material and over the preformed tube. The preformed tube includes multiple capillary pathways and multiple bends. The preformed tube represents at least a portion of a pulsating heat pipe within the heat exchanger, and the pulsating heat pipe is configured to transport the thermal energy through the heat exchanger.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIGS. 1A and 1B illustrate example electroformed heat exchangers with embedded pulsating heat pipes according to this disclosure;

FIG. 2 illustrates an example preformed tube for use as an embedded pulsating heat pipe within an electroformed heat exchanger according to this disclosure;

FIGS. 3A through 3G illustrate an example technique for forming an electroformed heat exchanger with an embedded pulsating heat pipe according to this disclosure; and

FIG. 4 illustrates an example method for forming an electroformed heat exchanger with an embedded pulsating heat pipe according to this disclosure.

### DETAILED DESCRIPTION

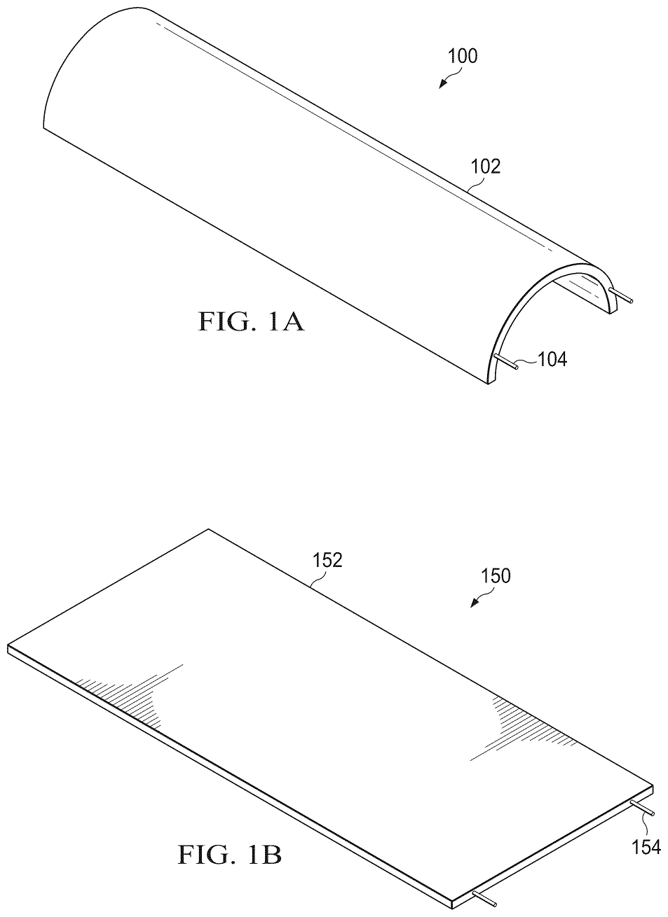

FIGS. 1A through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, thermal management is typically a desired or required function in many systems and is used to maintain the operating temperatures of electronic circuits or other components within acceptable temperature ranges. Various types of structures have been used in thermal management systems in order to remove thermal energy from electronic circuits or other components. Some of these structures rely on the use of fluid, such as liquid or vapor, to transport thermal energy.

A heat exchanger with a pulsating heat pipe is one type of structure used in certain thermal management systems. A pulsating heat pipe (also known as an oscillating heat pipe) refers to a structure in which fluid can travel through thin capillary pathways, where the fluid can take the form of liquid and/or vapor within the capillary pathways. One portion of the heat exchanger can receive thermal energy to be rejected or removed (such as from one or more components to be cooled), and another portion of the heat exchanger can be used to reject the thermal energy. The fluid, such as in the form of liquid-vapor slugs, can travel back and forth in order to transport the thermal energy from the portion of the heat exchanger receiving the thermal energy to the portion of the heat exchanger rejecting the thermal energy.

Heat exchangers with pulsating heat pipes are often manufactured using vacuum brazing processes. However, the use of vacuum brazing comes with various shortcomings or disadvantages. For example, structures fabricated using vacuum brazing often need to be planar (flat) and often need to include rectangular capillary pathways. Even if a flat heat exchanger is manufactured and later bent into a non-planar shape, bending stresses within the heat exchangers and the capillary pathways may limit the amount of bending that can be achieved. This can severely limit the shapes in which the heat exchangers can be formed, which can also limit the application of the heat exchangers. Moreover, due to pressures within the capillary pathways and other stresses on the heat exchangers, the heat exchangers often need to have specified thicknesses that can be larger than desired or required for specific applications.

This disclosure provides various embodiments of electroformed heat exchangers with embedded pulsating heat pipes. As described in more detail below, each electroformed heat exchanger may be fabricated using at least one preformed tube, where the at least one preformed tube represents a structure used to implement a pulsating heat pipe. A heat exchanger can be fabricated by depositing one or more suitable materials, such as one or more metals, around the at least one preformed tube. For example, the heat exchanger can be fabricated using electroforming of one or more suitable materials around the at least one preformed tube, such as via the electrodeposition or other electroformation of copper or other metal(s).

As a particular example of this process, a first portion of the electroformed material can be deposited on a mandrel, such as an aluminum or other mandrel. Once deposited, the at least one preformed tube can be positioned on the first portion of the electroformed material, and a second portion of the electroformed material can be deposited over the first portion of the electroformed material and over the at least one preformed tube. This helps to embed the at least one preformed tube within the electroformed material. The resulting structure can be cut, polished, or otherwise post-processed, and the mandrel can be dissolved or otherwise removed. This process thereby produces a heat exchanger that includes the at least one preformed tube embedded within the electroformed material and forming at least one pulsating heat pipe.

In this way, heat exchangers having various sizes and shapes may be fabricated and used in a wide variety of applications. For example, the mandrel on which electroformed material is deposited can have any of a wide variety of sizes and shapes, which allows a heat exchanger manufactured using the mandrel to also be formed having any of a wide variety of sizes and shapes. This allows for use of the heat exchangers in a much wider variety of applications, such as those in which non-planar or conformal heat exchangers are needed or desired. Moreover, the heat exchangers here need not be bent (or may not be bent as much compared to traditional vacuum-brazed heat exchangers) in order to achieve non-planar shapes, which can reduce the amount of bending stresses within the heat exchangers. In addition, the at least one preformed tube used to implement the at least one embedded pulsating heat pipe within a heat exchanger may be formed using one or more suitably-strong materials (such as stainless steel or other metal) and may have any suitable or desired cross-sectional shape (which may or may not be rectangular). This can help to provide improved structural support for the capillary pathways and the heat exchanger itself, which can allow the heat exchanger to handle higher fluid pressures within the pulsating heat pipe(s) and/or allow the overall thickness of the heat exchanger to be reduced (resulting in size, weight, and/or cost reductions).

Note that heat exchangers designed in accordance with this disclosure may be used in a number of thermal management applications. These thermal management applications can include various commercial and defense-related applications, such as those that involve the use of thin thermal planes, thin thermal skins, or other types of planar or non-planar heat exchangers. As particular examples, heat exchangers designed in accordance with this disclosure may be used in automobiles or other vehicles to remove thermal energy from one or more components of the vehicles, such as while providing for aerodynamic conformal heat transfer. Heat exchangers designed in accordance with this disclosure may be used in light emitting diode (LED) lightbulbs or other types of light-generating devices to remove thermal energy from one or more components of the light-generating devices. Heat exchangers designed in accordance with this disclosure may be used in missiles, drones, rockets, satellites, or other flight vehicles, such as vehicles in which cylindrical or complex geometric shapes are used. These applications are examples only and are provided merely to illustrate some ways in which heat exchangers may be used. In general, the heat exchangers designed in accordance with this disclosure may be used in any suitable thermal management applications, and this disclosure is not limited to any specific type(s) of application(s) for the heat exchangers.

FIGS. 1A and 1B illustrate example electroformed heat exchangers 100 and 150 with embedded pulsating heat pipes according to this disclosure. As shown in FIG. 1A, the heat exchanger 100 includes a body 102 and an embedded pulsating heat pipe 104. Note that only a portion of the embedded pulsating heat pipe 104 is visible in FIG. 1A, while a remaining portion of the embedded pulsating heat pipe 104 (and typically a substantial majority of the embedded pulsating heat pipe 104) is contained within the body 102 of the heat exchanger 100. Similarly, as shown in FIG. 1B, the heat exchanger 150 includes a body 152 and an embedded pulsating heat pipe 154. Note that only a portion of the embedded pulsating heat pipe 154 is visible in FIG. 1B, while a remaining portion of the embedded pulsating heat pipe 154 (and typically a substantial majority of the embedded pulsating heat pipe 154) is contained within the body 152 of the heat exchanger 150.

The body 102 and 152 of each heat exchanger 100 and 150 may be formed using any suitable material or materials, such as one or more metals like copper. The body 102 and 152 of each heat exchanger 100 and 150 may also be formed using any suitable electroformation process, such as an electrodeposition process. In addition, the body 102 and 152 of each heat exchanger 100 and 150 may have any suitable size, shape, and dimensions. In the examples shown here, the body 102 of the heat exchanger 100 takes the form of a half or other portion of an annular cylinder, and the body 152 of the heat exchanger 150 takes the form of a substantially planar structure. However, as noted above, each body 102 and 152 may be formed in any suitable planar or non-planar shape, such as through the use of a planar or non-planar mandrel that is used during the electroformation process. Thus, the two shapes of the bodies 102 and 152 shown in FIGS. 1A and 1B are examples only, and a heat exchanger having one or more embedded pulsating heat pipes may have any other suitable size and shape.

The pulsating heat pipe 104 and 154 of each heat exchanger 100 and 150 may be formed using any suitable material or materials, such as one or more metals like stainless steel. The pulsating heat pipe 104 and 154 of each heat exchanger 100 and 150 may also be formed in any suitable manner. For example, each pulsating heat pipe 104 and 154 may be fabricated using at least one preformed tube that is bent into a desired form and embedded within the body 102 and 152 of the heat exchanger 100 and 150. As a particular example, each pulsating heat pipe 104 and 154 may be fabricated using at least one thin preformed tube, such as hypodermic needle tubing, formed of stainless steel or other material(s). As described below, a portion of the body 102 and 152 of the heat exchanger 100 and 150 may be formed, at least one preformed tube forming a pulsating heat pipe 104 and 154 may be placed on that portion of the body 102 and 152, and another portion of the body 102 and 152 may be formed to embed the pulsating heat pipe 104 and 154 within the heat exchanger 100 and 150. In addition, the pulsating heat pipe 104 and 154 of each heat exchanger 100 and 150 may have any suitable size, shape, and dimensions. In the examples shown here, each pulsating heat pipe 104 and 154 includes small portions extending from sides of the associated body 102 and 152. Within the associated body 102 and 152, each pulsating heat pipe 104 and 154 may travel back and forth repeatedly to form a number of small capillary channels traveling back and forth within the body 102 and 152.

Although FIGS. 1A and 1B illustrate examples of electroformed heat exchangers 100 and 150 with embedded pulsating heat pipes, various changes may be made to FIGS. 1A and 1B. For example, each body 102 and 152 and each pulsating heat pipe 104 and 154 may have any other suitable form. Also, a heat exchanger may include one or multiple bodies, and each body of the heat exchanger may include one or multiple embedded pulsating heat pipes. In general, this disclosure is not limited to heat exchangers formed using a specified number of bodies or a specified number of embedded pulsating heat pipes. In addition, two ends of each pulsating heat pipe 104 and 154 are shown as extending outside of the respective body 102 and 152. However, in other embodiments, the two ends of a pulsating heat pipe 104 or 154 may meet at a “T”-shaped adapter such that only a portion of a single tube extends outside the body 102 or 152 (where that tube is fluidly coupled to the ends of the pulsating heat pipe 104 or 154 by the adapter). It is also possible to incorporate a check valve into a closed-loop pulsating heat pipe 104 or 154 in order to provide flow control of the fluid within the pulsating heat pipe 104 or 154.

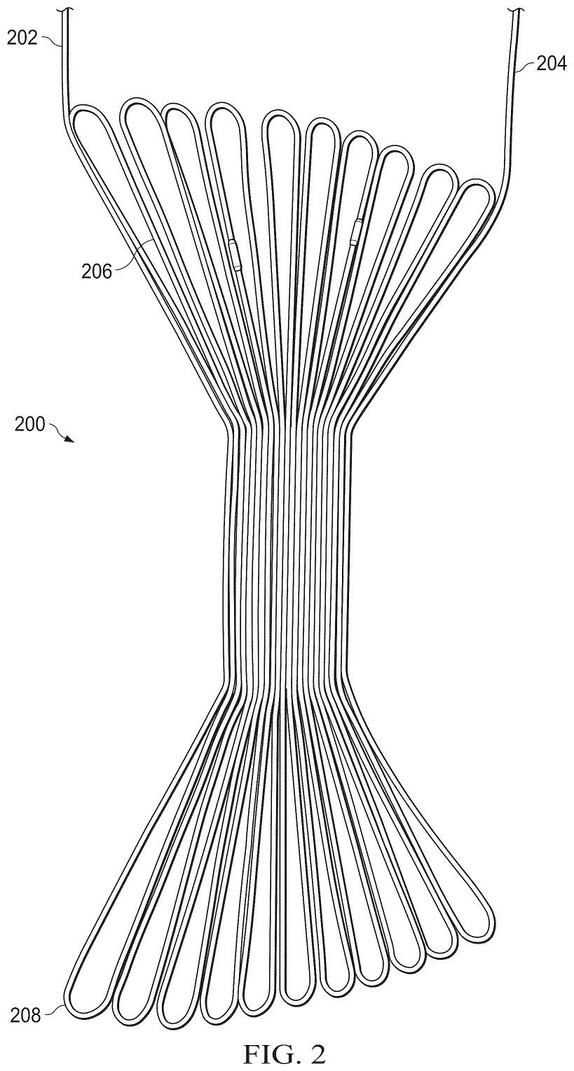

FIG. 2 illustrates an example preformed tube 200 for use as an embedded pulsating heat pipe within an electroformed heat exchanger according to this disclosure. For ease of explanation, the preformed tube 200 shown in FIG. 2 is described as being used to form the pulsating heat pipe 104 of the heat exchanger 100 shown in FIG. 1A or the pulsating heat pipe 154 of the heat exchanger 150 shown in FIG. 1B. However, the preformed tube 200 may be used to form any other suitable pulsating heat pipe in any other suitable heat exchanger.

As shown in FIG. 2, the preformed tube 200 takes the form of a thin preformed tube, such as hypodermic needle tubing. The preformed tube 200 may be formed from any suitable material(s), such as stainless steel or other metal(s). The preformed tube 200 may also have any suitable cross-sectional shape, such as circular, rectangular, or other shape. In this example, the preformed tube 200 includes two ends 202 and 204, which represent portions of the preformed tube 200 that can extend outside of, away from, or otherwise be accessible from outside of a body of a heat exchanger (such as the body 102 or 152 of the heat exchanger 100 or 150). For example, these ends 202 and 204 of the preformed tube 200 may be coupled to one or more external fluid pathways or other components that can be used to inject fluid into the preformed tube 200 or that can otherwise cooperate or interact with the preformed tube 200.

The preformed tube 200 also includes a number of capillary pathways 206 that extend back and forth and that are fluidly joined to one another via bends 208 in the preformed tube 200. When the preformed tube 200 is embedded within a body of a heat exchanger, each capillary pathway 206 may extend between a “warm” end of the heat exchanger and a “cool” end of the heat exchanger. The warm end of the heat exchanger can represent the portion of the heat exchanger that receives thermal energy, such as from one or more components to be cooled. The cool end of the heat exchanger can represent the portion of the heat exchanger that rejects thermal energy. During operation, a self-sustaining oscillatory flow of fluid can occur within the capillary pathways 206. Due to this oscillatory flow of the fluid, a liquid-vapor circulation cycle can exist between the warm and cool ends of the heat exchanger, allowing thermal energy to be transferred by the fluid as latent heat within the heat exchanger.

In this particular example, the capillary pathways 206 run parallel or substantially parallel to one another in the middle portions of the capillary pathways 206, and the capillary pathways 206 separate from one another to provide space for the bends 208. The close proximity of portions of the capillary pathways 206 may allow for the transfer of thermal energy between the capillary pathways 206, which may help to at least partially equalize the temperatures of the fluid in the capillary pathways 206. Note, however, that the capillary pathways 206 may follow any other suitable paths between the bends 208 and between the warm and cool ends of the heat exchanger. Also note that while the bends 208 are shown here as being generally planar with one another, this is not necessarily required. For instance, if a larger thickness of a heat exchanger is desired or permitted, adjacent bends 208 may partially overlap one another.

As can be seen here, the preformed tube 200 can be fabricated or manipulated to have a desired shape for a pulsating heat pipe. For example, the preformed tube 200 may be used during electroforming of the body of a heat exchanger (such as the body 102 or 152) and embedded within the body of the heat exchanger. As a particular example, electroforming of the body of the heat exchanger may be partially performed and then paused, and the preformed tube 200 may be placed on the electroformed material. Electroforming of the body of the heat exchanger may then be completed. As a result, the preformed tube 200 can be encased within the metal or other material(s) during the electroforming process, and the preformed tube 200 can be used as a pulsating heat pipe within the heat exchanger.

Note that the amount of fluid (liquid and/or vapor) within the pulsating heat pipe formed by the preformed tube 200 can be controlled in order to provide desired performance characteristics of the resulting heat exchanger. For example, larger amounts of liquid may allow for larger quantities of thermal energy to be transferred but may be associated with higher pressures within the pulsating heat pipe. Conversely, smaller amounts of liquid may allow for smaller quantities of thermal energy to be transferred but may be associated with lower pressures within the pulsating heat pipe. The design of the preformed tube 200, the design of the heat exchanger in which the preformed tube 200 is embedded, and/or the quantity of fluid within the preformed tube 200 can all be customized based on specific needs in order to provide a heat exchanger with desired performance characteristics.

Although FIG. 2 illustrates one example of a preformed tube 200 for use as an embedded pulsating heat pipe within an electroformed heat exchanger, various changes may be made to FIG. 2. For example, the preformed tube 200 may define any suitable number of capillary pathways 206 and bends 208. Also, the preformed tube 200 may have any other suitable design that allows for the transport of fluid in order to enable heat transfer within a heat exchanger.

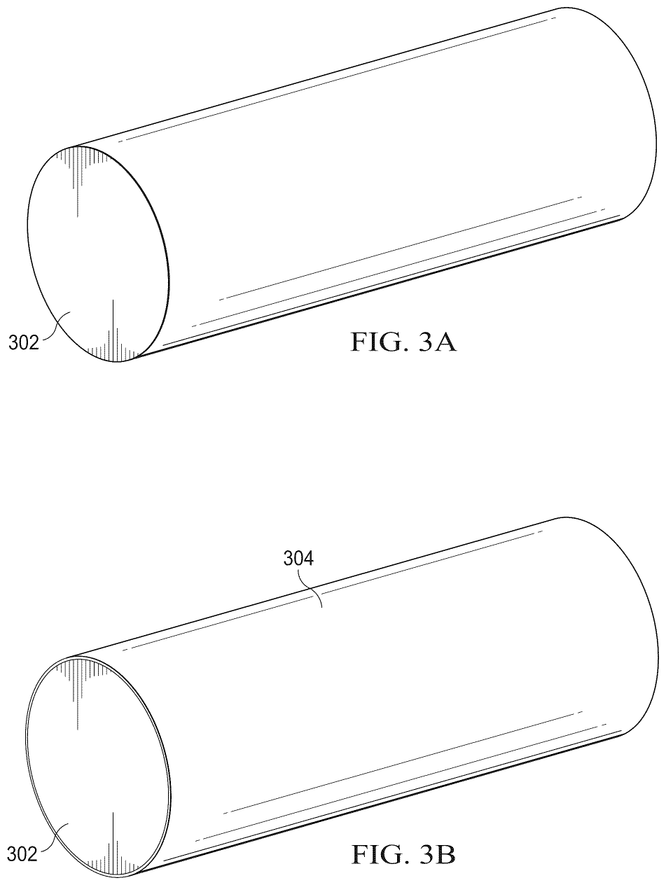

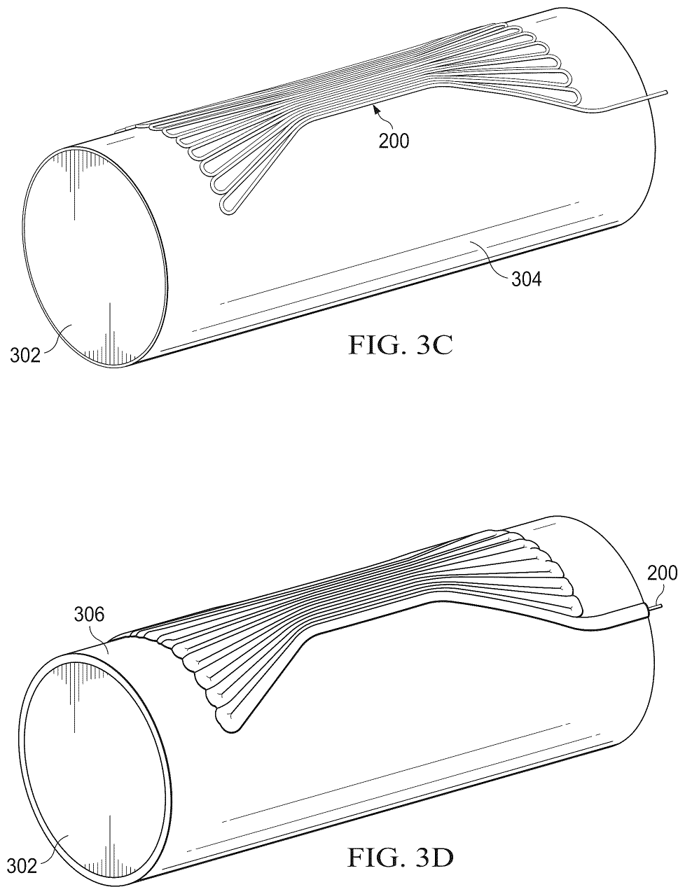

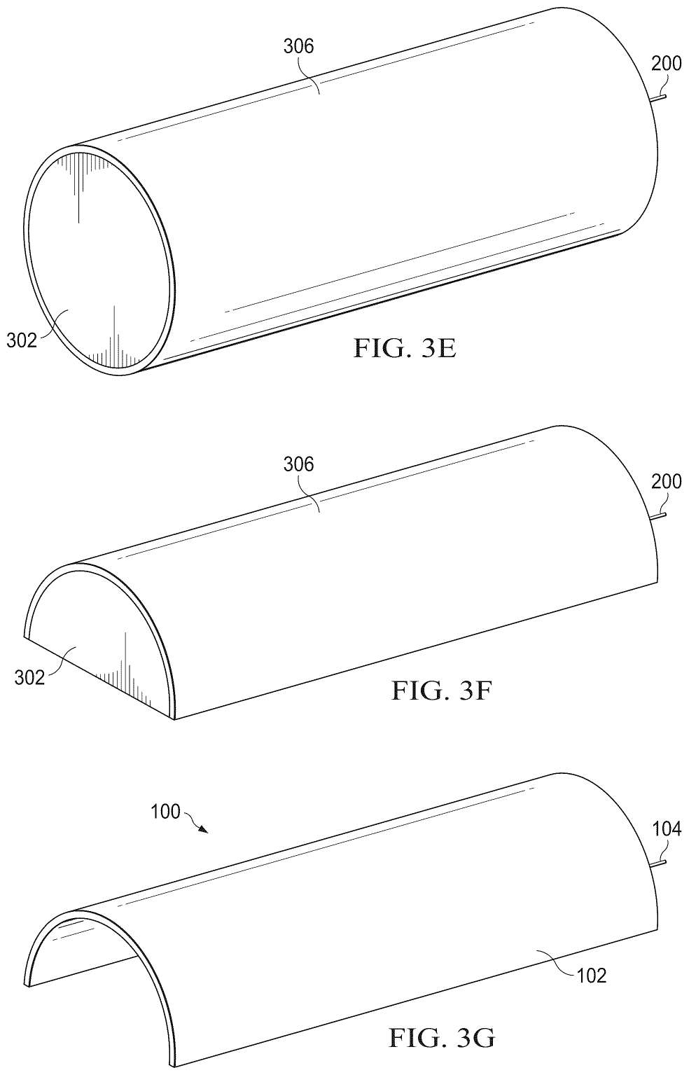

FIGS. 3A through 3G illustrate an example technique for forming an electroformed heat exchanger with an embedded pulsating heat pipe according to this disclosure. For ease of explanation, the technique shown in FIGS. 3A through 3G is described as being used to form the heat exchanger 100 shown in FIG. 1A. However, the technique may be used to form any other suitable heat exchanger, such as the heat exchanger 150 shown in FIG. 1B.

As shown in FIG. 3A, a mandrel 302 may be obtained, where the mandrel 302 defines at least the general or initial shape (and possibly the final shape) of at least one heat exchanger to be fabricated via electroforming. In this example, the mandrel 302 has the shape of a cylinder, which allows the body 102 of a heat exchanger 100 to be formed having a shape that matches the curved outer surface of the mandrel 302. However, as noted above, heat exchangers fabricated via electroforming may have a wide variety of planar and non-planar shapes, including heat exchangers with complex geometries. Thus, the specific mandrel 302 shown here is for illustration only, and the shape of the mandrel 302 can easily vary based on the shape of the heat exchanger(s) to be formed. The mandrel 302 may be formed from any suitable material(s), such as aluminum.

As shown in FIG. 3B, a first portion of material 304 is deposited on the mandrel 302. The first portion of material 304 here may represent any suitable material(s) that can be deposited during an electroforming process, such as one or more metals. In some cases, the first portion of material 304 may represent copper. Depending on the implementation, the first portion of material 304 deposited on the mandrel 302 may have a relatively large or relatively small thickness. The thickness of the first portion of material 304 being deposited and the thickness of the overall heat exchanger being fabricated can vary depending on particular needs. Note that while the first portion of material 304 here is shown as being deposited only on the curved surface of the mandrel 302, some of the first portion of material 304 may be formed on the end(s) of the mandrel 302 and removed during subsequent processing.

As shown in FIG. 3C, the electroforming process can be paused or interrupted in order to allow at least one preformed tube (such as the preformed tube 200) to be placed onto the first portion of material 304 as deposited on the mandrel 302. As can be seen in FIG. 3C, the preformed tube 200 may have a relatively small height above the first portion of material 304, which in some embodiments thereby allows a pulsating heat pipe to be embedded within a generally-thin heat exchanger. Also, as can be seen in FIG. 3C, the preformed tube 200 may be bent somewhat in order to place the preformed tube 200 onto the surface of the first portion of material 304. However, because it is the preformed tube 200 (and not the overall heat exchanger) that is bent, there may be little or no concern here related to bending stresses within the heat exchanger. Note that any suitable mechanism may be used here to hold the preformed tube 200 on the structure shown in FIG. 3C (if needed), such as a mechanical constraint, an adhesive, or other suitable mechanism.

As shown in FIGS. 3D and 3E, a second portion of material 306 is deposited on the first portion of material 304 and the preformed tube 200. The material 306 here may represent any suitable material(s) that can be deposited during an electroforming process, such as one or more metals. In some cases, the material 306 may represent copper. Depending on the implementation, the second portion of material 306 deposited on the first portion of material 304 and the preformed tube 200 may have a relatively large or relatively small thickness. The thickness of the second portion of material 306 being deposited and the thickness of the overall heat exchanger being fabricated can vary depending on particular needs. Note that while the second portion of material 306 here is shown as being deposited only on the curved surface of the material 304 and the preformed tube 200, some of the second portion of material 306 may be formed on the end(s) of the mandrel 302 and removed during subsequent processing. Thus, for instance, any excess material of the first and/or second portions of material 304 and 306 can be machined or otherwise removed as necessary. In this particular example, the second portion of material 306 is shown as substantially hiding the preformed tube 200, meaning the outer surface of the second portion of material 306 is shown as being relatively smooth. However, this is for illustration only and need not occur in all instances.

As shown in FIGS. 3F and 3G, the lower half of the structure can be removed, such as via mechanical etching or cutting, laser cutting, or some other mechanism. Also, the remaining portion of the mandrel 302 can be dissolved or otherwise removed in order to form one instance of the heat exchanger 100. As can be seen here, this approach allows for a relatively-thin heat exchanger 100 to be produced, where the heat exchanger 100 includes an embedded pulsating heat pipe 104 within the relatively-thin structure. The same or similar type of approach may be used to fabricate heat exchangers having other shapes and/or arrangements of embedded pulsating heat pipes. After the structure shown in FIG. 3G is obtained, the structure may optionally be bent or otherwise processed into a final form for use. However, because the pulsating heat pipe 104 here is formed using a preformed tube 200 embedded within the heat exchanger 100, there can be less concern that this bending induces excessive stresses within the heat exchanger 100.

Note that in this particular example, the lower half of the structure shown in FIG. 3E is removed, and the upper half of the structure shown in FIG. 3E is processed to form one instance of the heat exchanger 100. However, it may be possible to form another instance of the heat exchanger 100 using the lower half of the structure shown in FIG. 3E. Thus, for instance, another preformed tube 200 may be attached to the lower half of the structure shown in FIG. 3E and used to form a second instance of the heat exchanger 100. Depending on the design of the heat exchanger being fabricated and the design of the mandrel being used, one or any number of heat exchangers may be fabricated from a common electroformed structure.

Although FIGS. 3A through 3G illustrate one example of a technique for forming an electroformed heat exchanger with an embedded pulsating heat pipe, various changes may be made to FIGS. 3A through 3G. For example, the mandrel and heat exchanger may each have any suitable size, shape, and dimensions. Also, a heat exchanger may include one or multiple embedded pulsating heat pipes.

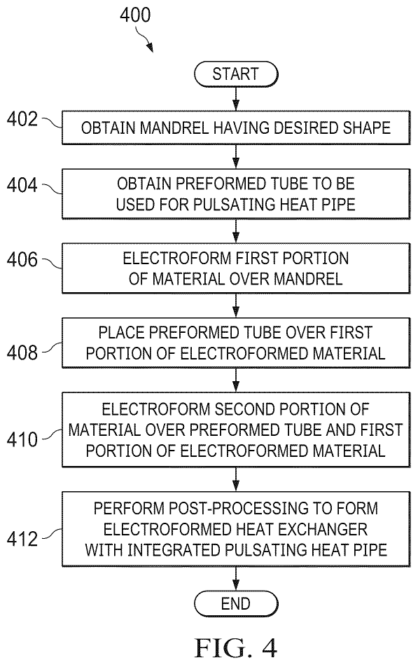

FIG. 4 illustrates an example method 400 for forming an electroformed heat exchanger with an embedded pulsating heat pipe according to this disclosure. For ease of explanation, the method 400 shown in FIG. 4 is described as being used to form the heat exchanger 100 shown in FIG. 1A or the heat exchanger 150 shown in FIG. 1B. However, the method 400 may be used to form any other suitable heat exchanger designed in accordance with this disclosure.

As shown in FIG. 4, a mandrel having a desired shape is obtained at step 402. This may include, for example, manufacturing or otherwise obtaining a mandrel 302 having at least one surface that matches at least the initial shape (and possibly the final shape) of at least one heat exchanger to be fabricated. The mandrel 302 may have any desired shape based on the heat exchanger(s) to be fabricated, such as a planar or non-planar shape and possibly a very complex geometrical shape if desired. The mandrel 302 may be formed from any suitable material(s), such as aluminum. At least one preformed tube to be used for forming at least one pulsating heat pipe is obtained at step 404. This may include, for example, manufacturing or otherwise obtaining at least one preformed tube 200 that is or can be shaped to have a desired number of capillary pathways 206 and bends 208. The preformed tube 200 may have any desired shape based on the pulsating heat pipe(s) to be embedded within a heat exchanger. The preformed tube 200 may be formed from any suitable material(s), such as stainless steel or other metal.

A first portion of material is electroformed over the mandrel at step 406. This may include, for example, performing an electroforming process to deposit a first portion of material 304 over the mandrel 302. As a particular example, this may include performing an electroforming process to deposit copper over the mandrel 302. The at least one preformed tube is placed over the first portion of electroformed material at step 408. This may include, for example, placing the at least one preformed tube 200 onto the first portion of material 304 and (optionally) using a mechanical constraint, adhesive, or other suitable mechanism to hold the at least one preformed tube 200 on the first portion of material 304. A second portion of material is electroformed over the first portion of material and the at least one preformed tube at step 410. This may include, for example, performing an electroforming process to deposit a second portion of material 306 over the first portion of material 304 and the at least one preformed tube 200. As a particular example, this may include performing an electroforming process to deposit additional copper over the first portion of material 304 and the at least one preformed tube 200. This encases all or a substantial portion of the at least one preformed tube 200 within the first and second materials 304 and 306.

One or more suitable post-processing operations may occur to produce an electroformed heat exchanger with at least one integrated pulsating heat pipe at step 412. This may include, for example, machining or otherwise removing any unnecessary copper or other material(s) deposited during the electroforming operations. This may also include cutting the electroformed structure as needed and/or dissolving the mandrel 302. In addition, this may include bending the electroformed structure into a desired final form for a heat exchanger.

Although FIG. 4 illustrates one example of a method 400 for forming an electroformed heat exchanger with an embedded pulsating heat pipe, various changes may be made to FIG. 4. For example, while shown as a series of steps, various steps in FIG. 4 may overlap, occur in parallel, occur in a different order, or occur any number of times.

The following describes example embodiments of this disclosure that implement or relate to an electroformed heat exchanger with an embedded pulsating heat pipe. However, other embodiments may be used in accordance with the teachings of this disclosure.

In a first embodiment, a method includes using electroforming to deposit a first portion of material. The method also includes placing a preformed tube on the first portion of material, where the preformed tube includes multiple capillary pathways and multiple bends. The method further includes using electroforming to deposit a second portion of material over the first portion of material and over the preformed tube to form a heat exchanger. The preformed tube forms at least a portion of a pulsating heat pipe within the heat exchanger, and the pulsating heat pipe is configured to transport thermal energy through the heat exchanger.

In a second embodiment, an apparatus includes a heat exchanger having a first portion of electroformed material, a preformed tube over the first portion of electroformed material, and a second portion of electroformed material over the first portion of electroformed material and over the preformed tube. The preformed tube includes multiple capillary pathways and multiple bends. The preformed tube represents at least a portion of a pulsating heat pipe within the heat exchanger, and the pulsating heat pipe is configured to transport thermal energy through the heat exchanger.

In a third embodiment, a method includes transporting thermal energy through a heat exchanger. The heat exchanger includes a first portion of electroformed material, a preformed tube over the first portion of electroformed material, and a second portion of electroformed material over the first portion of electroformed material and over the preformed tube. The preformed tube includes multiple capillary pathways and multiple bends. The preformed tube represents at least a portion of a pulsating heat pipe within the heat exchanger, and the pulsating heat pipe is configured to transport the thermal energy through the heat exchanger.

Any single one or any suitable combination of the following features may be used with the first, second, or third embodiment. Electroforming may be used to deposit the first portion of material onto a mandrel. The mandrel may be dissolved after the heat exchanger is formed. The preformed tube may further include first and second ends, the first and second materials may form a body of the heat exchanger, and the first and second ends of the preformed tube may extend outside of the body. The first and second portions of material may encase all or substantially all of the preformed tube. The first and second portions of material may be deposited during electroforming such that the heat exchanger has a non-planar shape. The first and second portions of material may include copper, and the preformed tube may include stainless steel. The preformed tube may include hypodermic needle tubing. The heat exchanger may be bent or be bendable to achieve a final shape for the heat exchanger. The preformed tube may have a circular cross-sectional shape. The capillary pathways may extend between a warm end of the heat exchanger and a cool end of the heat exchanger.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
using electroforming to deposit a first portion of material;
placing a preformed tube on the first portion of material, the preformed tube comprising multiple capillary pathways and multiple bends; and
using electroforming to deposit a second portion of material over the first portion of material and over the preformed tube to form a heat exchanger;
wherein the preformed tube forms at least a portion of a pulsating heat pipe within the heat exchanger, the pulsating heat pipe configured to transport thermal energy through the heat exchanger.

2. The method of claim 1, wherein using electroforming to deposit the first portion of material comprises using electroforming to deposit the first portion of material onto a mandrel.

3. The method of claim 2, further comprising:
dissolving the mandrel after the heat exchanger is formed.

4. The method of claim 1, wherein:
the preformed tube further comprises first and second ends;
the first and second materials form a body of the heat exchanger; and
the first and second ends of the preformed tube extend outside of the body.

5. The method of claim 1, wherein the first and second portions of material encase all or substantially all of the preformed tube.

6. The method of claim 1, wherein the first and second portions of material are deposited during the electroforming such that the heat exchanger has a non-planar shape.

7. The method of claim 1, wherein:
the first and second portions of material comprise copper; and
the preformed tube comprises stainless steel.

8. The method of claim 1, wherein the preformed tube comprises hypodermic needle tubing.

9. The method of claim 1, further comprising:
bending the heat exchanger to achieve a final shape for the heat exchanger.

10. The method of claim 1, wherein the preformed tube has a circular cross-sectional shape.

11. An apparatus comprising:
a heat exchanger comprising:
a first portion of electroformed material;
a preformed tube over the first portion of electroformed material, the preformed tube comprising multiple capillary pathways and multiple bends; and
a second portion of electroformed material over the first portion of electroformed material and over the preformed tube;
wherein the preformed tube represents at least a portion of a pulsating heat pipe within the heat exchanger, the pulsating heat pipe configured to transport thermal energy through the heat exchanger.

12. The apparatus of claim 11, wherein:
the preformed tube further comprises first and second ends;
the first and second materials form a body of the heat exchanger; and
the first and second ends of the preformed tube extend outside of the body.

13. The apparatus of claim 11, wherein the first and second portions of electroformed material encase all or substantially all of the preformed tube.

14. The apparatus of claim 11, wherein the heat exchanger has a non-planar shape.

15. The apparatus of claim 11, wherein:
the first and second portions of electroformed material comprise copper; and
the preformed tube comprises stainless steel.

16. The apparatus of claim 11, wherein the preformed tube comprises hypodermic needle tubing.

17. The apparatus of claim 11, wherein the heat exchanger is bendable into a final shape.

18. The apparatus of claim 11, wherein the preformed tube has a circular cross-sectional shape.

19. A method comprising:
transporting thermal energy through a heat exchanger;
wherein the heat exchanger comprises:
a first portion of electroformed material;
a preformed tube over the first portion of electroformed material, the preformed tube comprising multiple capillary pathways and multiple bends; and
a second portion of electroformed material over the first portion of electroformed material and over the preformed tube;
wherein the preformed tube represents at least a portion of a pulsating heat pipe within the heat exchanger, the pulsating heat pipe configured to transport the thermal energy through the heat exchanger.

20. The method of claim 19, wherein the capillary pathways extend between a warm end of the heat exchanger and a cool end of the heat exchanger.
